(19) United States
(12) Patent Application Publication
(10) Pub. No.: US 2015/0220887 A1
(43) Pub. Date: Aug. 6, 2015

(54) MOBILE SCHEDULING APPLICATION AND SYSTEM

(71) Applicant: EVERSEAT, INC., OWINGS MILLS, MD (US)

(72) Inventors: Jeffrey Peres, Owings Mills, MD (US); Brian Kaplan, Owings Mills, MD (US)

(21) Appl. No.: 14/612,154

(22) Filed: Feb. 2, 2015

Related U.S. Application Data
(60) Provisional application No. 61/933,994, filed on Jan. 31, 2014.

(51) Int. Cl. G06Q 10/10

(52) U.S. Cl. CPC G06Q 10/1095

(57) ABSTRACT

A computer system, computer readable medium and computer-implemented method includes connecting to a database on a server that maintains schedule data of third parties; monitoring desired appointments of at least one subscriber account against the availability profiles of the at least one third party entry of the schedule data in the database; receiving a cancellation of an appointment; updating the availability profile of the third party entry in the database that corresponds to the canceled appointment; creating a cancellation notification based on existing desired appointments for the third party entry; sending a cancellation notification to at least one of the at least one subscriber; accepting input related to the cancellation notification from subscribers to whom a cancellation notification was sent; updating the database to add the canceled appointment and associated subscriber information from a subscriber based on the input from the subscribers; and notifying about the updated canceled appointment.

### CROSS-REFERENCE TO RELATED APPLICATIONS

This application claims priority to U.S. Provisional Patent Application No. 61/933,994 filed Jan. 31, 2014, which is hereby incorporated by reference herein in its entirety.

### FIELD

This disclosure relates generally to managing and scheduling appointments, and more particularly to methods, system, and media for mobile scheduling of appointments.

### BACKGROUND

Unfilled appointments mean lost revenue for service providers and lost opportunities for consumers. For service providers (doctors, dentists, hair stylists, manicurists, trainers, etc.), embodiments of the invention efficiently solves the problem of lost revenue from same-day and next-day cancellations. Finding last minute customers is time-consuming, manual and often unsuccessful. For consumers, a lack of transparency and process around booking cancelled (often coveted) appointments means last minute openings are simply unknown. Busy, overwhelmed consumers as well as chronic procrastinators cannot find the right services at the right time. Calling or waiting for a call from a receptionist is inefficient and often unsuccessful.

There are well over one million service providers in the United States. This market breaks down into the following broad categories:

900,000 doctors

185,000 physical therapists

100,000 veterinarians

150,000 nail salons

100,000 hair salons

20,000 spas

200,000 fitness trainers, yoga studios, Pilates studios

On the consumer side, more than 61% of Americans now have smart phones according to Pew. This represents over 150 million people in the United States. The size of the market is likely materially larger because there are over 1,000,000 providers in the US and each provider has an average of more than 1,000 consumers in their database—with some medical providers having more than 5,000 consumers.

With advances in information technologies, there exists a need for methods and systems to connect service providers and consumers and that address the aforementioned problems.

### SUMMARY

Various embodiments are generally directed to overcome the aforementioned problems. Embodiments of the invention enable service providers to push out last minute availability without picking up the phone. Providers have a built-in consumer base (their customers) that download the application, set their preferences, and book an appointment at no cost, directly from the app. Providers can gain incremental customers from the “network effect” of the app.

In one aspect, a computer system for managing third party availability profiles, includes a memory that is configured to store computer-executable instructions; and at least one processor that is coupled to the memory and that is configured to execute the computer-executable instructions to perform: connecting to a database on a server that maintains schedule data of third parties, the schedule data having at least one third party entry that includes a service type and service time, each of the at least one third party entry having an availability profile; monitoring desired appointments of at least one subscriber account against the availability profiles of the at least one third party entry of the schedule data in the database, each of the desired appointments including a type and time of service, at least one desired appointment corresponding to the at least one third party entry; receiving a cancellation of an appointment, the appointment corresponding to one or more of the third party entries of the third parties; updating the availability profile of the third party entry in the database that corresponds to the canceled appointment; creating a cancellation notification based on existing desired appointments for the third party entry, the cancellation notification being associated with a service type and service time of the schedule data; sending a cancellation notification to at least one of the at least one subscriber, the sending taking place based on the at least one subscriber activating the type and time of service that corresponds to the service type and service time of the cancellation notification; accepting input related to the cancellation notification from subscribers to whom a cancellation notification was sent; updating the database to add the canceled appointment and associated subscriber information from a subscriber based on the input from the subscribers; and notifying at least one of: i) the third party that corresponds to the canceled appointment and ii) the at least one subscriber that accepted the input related to the cancellation notification, about the updated canceled appointment.

In another aspect, a computer-implemented method for managing third party availability profiles, includes connecting to a database on a server that maintains schedule data of third parties, the schedule data having at least one third party entry that includes a service type and service time, each of the at least one third party entry having an availability profile; monitoring desired appointments of at least one subscriber account against the availability profiles of the at least one third party entry of the schedule data in the database, each of the desired appointments including a type and time of service, at least one desired appointment corresponding to the at least one third party entry; receiving a cancellation of an appointment, the appointment corresponding to one or more of the third party entries of the third parties; updating the availability profile of the third party entry in the database that corresponds to the canceled appointment; creating a cancellation notification based on existing desired appointments for the third party entry, the cancellation notification being associated with a service type and service time of the schedule data; sending a cancellation notification to at least one of the at least one subscriber, the sending taking place based on the at least one subscriber activating the type and time of service that corresponds to the service type and service time of the cancellation notification; accepting input related to the cancellation notification from subscribers to whom a cancellation notification was sent; updating the database to add the canceled appointment and associated subscriber information from a subscriber based on the input from the subscribers; and notifying at least one of: i) the third party that corresponds to the canceled appointment and ii) the at least one subscriber that accepted the input related to the cancellation notification, about the updated canceled appointment.

In another aspect, a non-transitory computer readable storage medium has instructions that, when executed by at least one processor, causes a computing system to perform steps of: connecting to a database on a server that maintains schedule data of third parties, the schedule data having at least one third party entry that includes a service type and service time, each of the at least one third party entry having an availability profile; monitoring desired appointments of at least one subscriber account against the availability profiles of the at least one third party entry of the schedule data in the database, each of the desired appointments including a type and time of service, at least one desired appointment corresponding to the at least one third party entry; receiving a cancellation of an appointment, the appointment corresponding to one or more of the third party entries of the third parties; updating the availability profile of the third party entry in the database that corresponds to the canceled appointment; creating a cancellation notification based on existing desired appointments for the third party entry, the cancellation notification being associated with a service type and service time of the schedule data; sending a cancellation notification to at least one of the at least one subscriber, the sending taking place based on the at least one subscriber activating the type and time of service that corresponds to the service type and service time of the cancellation notification; accepting input related to the cancellation notification from subscribers to whom a cancellation notification was sent; updating the database to add the canceled appointment and associated subscriber information from a subscriber based on the input from the subscribers; and notifying at least one of: i) the third party that corresponds to the canceled appointment and ii) the at least one subscriber that accepted the input related to the cancellation notification, about the updated canceled appointment.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a block diagram of a computer system 100, in accordance with one or more embodiments.

FIG. 2A depicts a flow diagram of a method, in accordance with one or more embodiments.

FIG. 2B depicts a flow diagram of a method, in accordance with one or more embodiments.

FIG. 3 depicts a display for a user, in accordance with one or more embodiments.

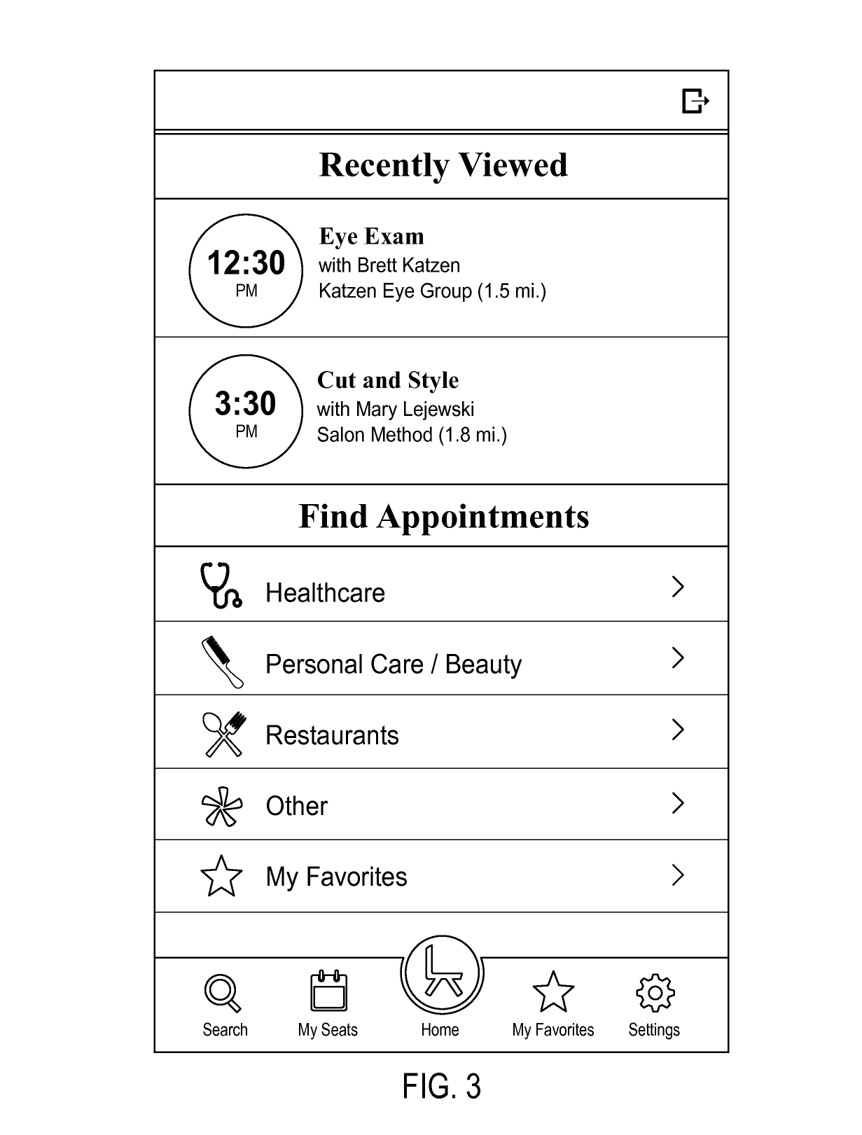

FIG. 4A shows available appointments, in accordance with one or more embodiments.

FIG. 4B shows a display of places, in accordance with one or more embodiments.

FIG. 4C shows a display of practitioners, in accordance with one or more embodiments.

FIG. 5A shows a display of an appointment, in accordance with one or more embodiments.

FIG. 5B shows a display of a confirmation, in accordance with one or more embodiments.

FIG. 6A shows an interface for selecting desired service providers, in accordance with one or more embodiments.

FIG. 6B shows an interface for selecting desired practitioners, in accordance with one or more embodiments.

FIG. 7A shows a view from a perspective of appointments related to a service provider, in accordance with one or more embodiments.

FIG. 7B shows view from a perspective of practitioners of the service provider, in accordance with one or more embodiments.

FIG. 8A shows an expanded view of the available appointments of the practitioner, in accordance with one or more embodiments.

FIG. 8B shows an interface detailing specific information regarding the practitioner, in accordance with one or more embodiments.

FIG. 9A shows a display of a user's upcoming appointments, in accordance with one or more embodiments.

FIG. 9B shows a display of a user's previous appointments, in accordance with one or more embodiments.

FIG. 10 shows a user settings display, in accordance with one or more embodiments.

FIG. 11 shows a flowchart of a service provider inputting information, in accordance with one or more embodiments.

FIG. 12 depicts an exemplary architecture for implementing a computing device in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

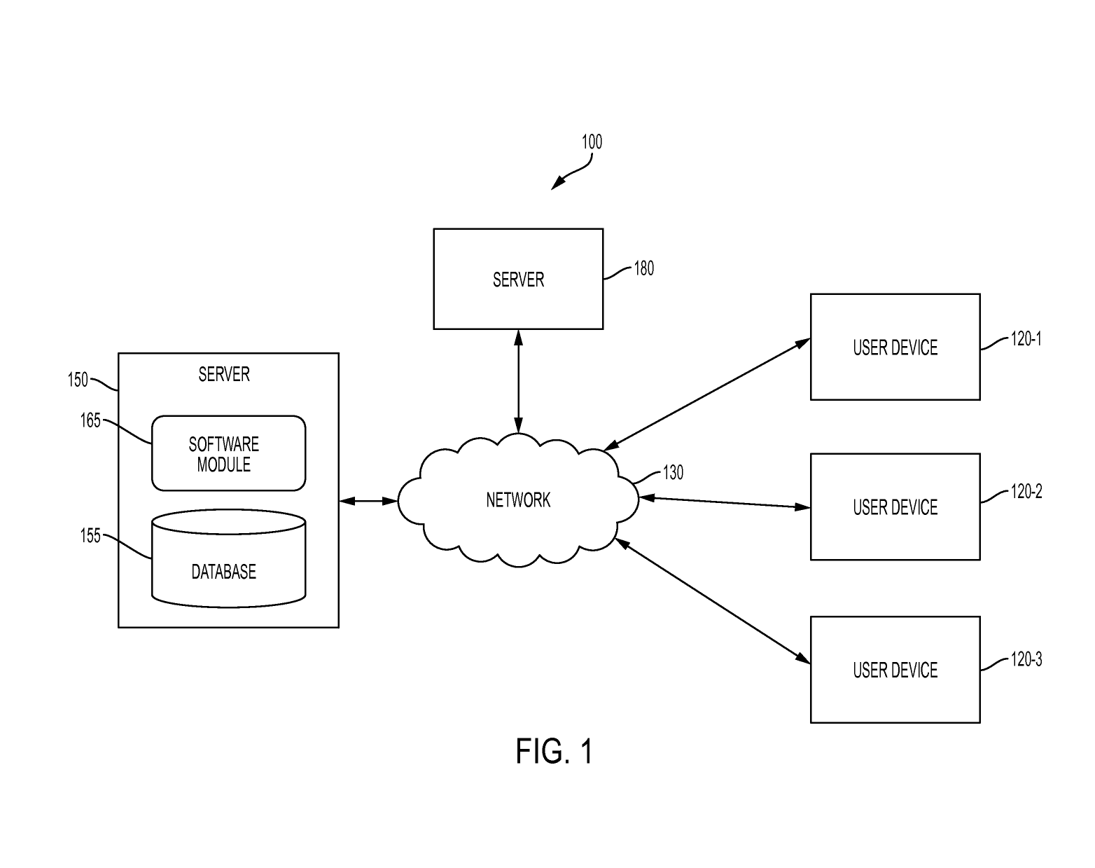

FIG. 1 depicts a block diagram of an exemplary computer system 100 in accordance with one or more embodiments. System 100 may include one or more user devices, e.g. user device 120-1, user device 120-2, and user device 120-3, network 130, server 150, database 155, software module 165, and server 180.

The one or more user devices, e.g. user device 120-1, user device 120-2, and user device 120-3, may be any type of computing device, including a mobile telephone, a laptop, tablet, or desktop computer having, a netbook, a video game device, a pager, a smart phone, an ultra-mobile personal computer (UMPC), or a personal data assistant (PDA). The one or more user devices may run one or more applications, such as Internet browsers, mobile applications, voice calls, video games, videoconferencing, and email, among others. The one or more user devices may be any combination of computing devices. These devices may be coupled to network 130.

Network 130 may provide network access, data transport and other services to the devices coupled to it. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

FIG. 1 shows an embodiment of the present invention. In FIG. 1, a computer system 100 for managing third party availability profiles can include a memory that is configured to store computer-executable instructions. The computer system 100 can include at least one processor that is coupled to the memory and that is configured to execute the computer-executable instructions to perform certain functions. The at least one processor and the memory can reside on server 150. Server 150 or server 180 may also be any type of computing device coupled to network 130, including but not limited to a personal computer, a server computer, a series of server computers, a mini computer, and a mainframe computer, or combinations thereof. Server 150 or server 180 may be a web server (or a series of servers) running a network operating system, examples of which may include but are not limited to Microsoft Windows Server, Novell NetWare, or Linux. Server 150 or server 180 may be used for and/or provide cloud and/or network computing. Although not shown in FIG. 1, server 150 and or server 180 may have connections to external systems like email, SMS messaging, text messaging, ad content providers, etc. Any of the features of server 150 may be also implemented in server 180 and vice versa.

Database 155 may be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Software module 165 may be a module that is configured to send, process, and receive information at server 150. Software module 165 may provide another mechanism for sending and receiving data at server 150 besides handling requests through web server functionalities. Software module 165 may send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof

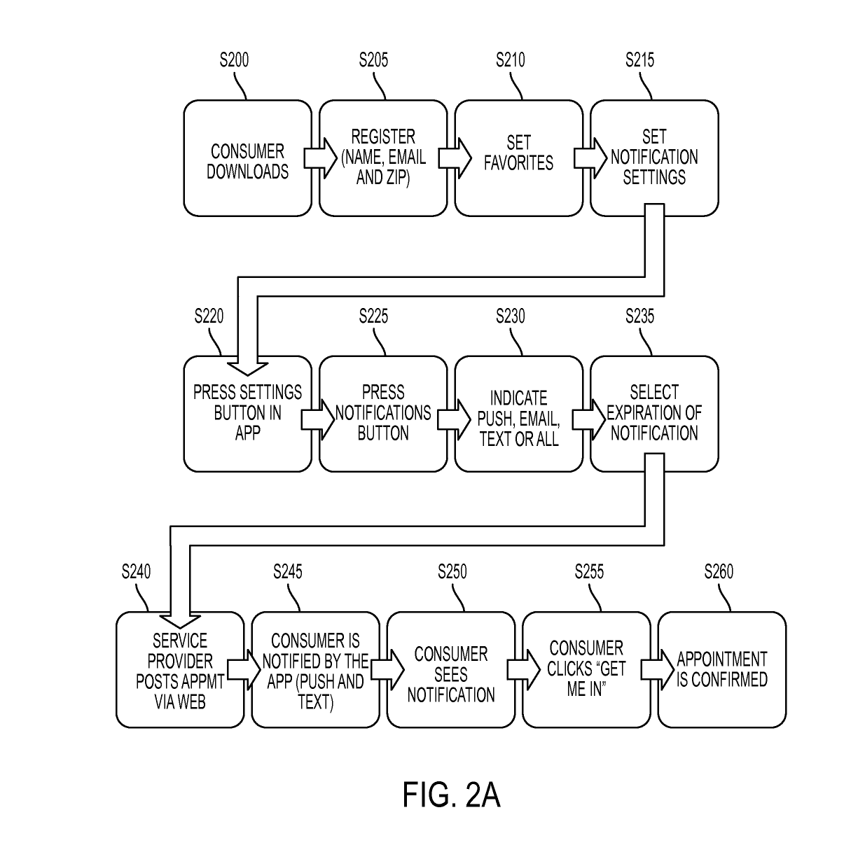

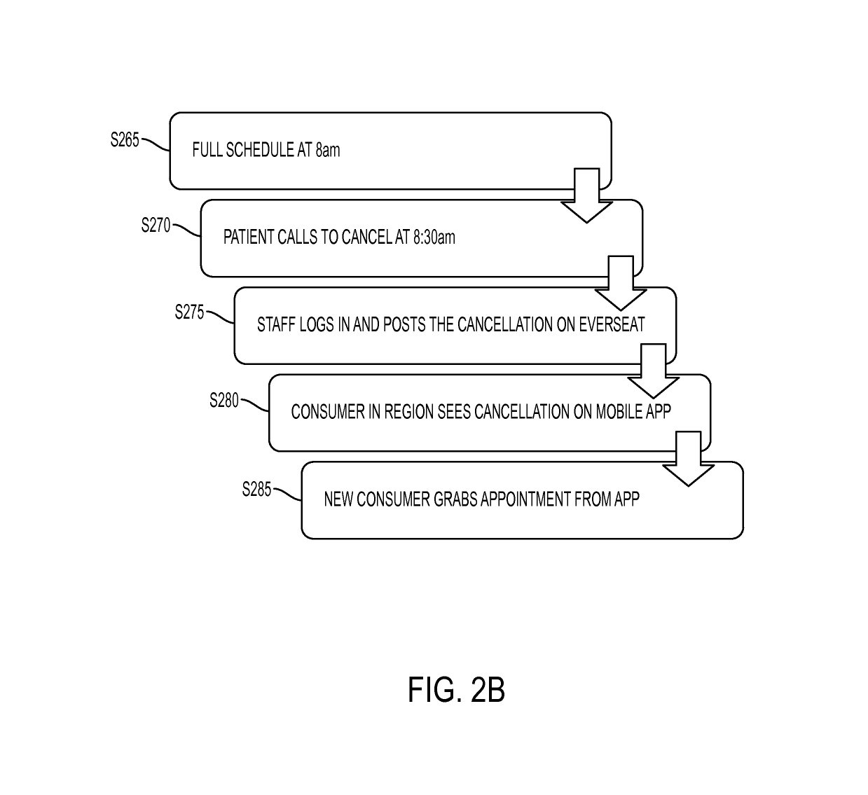

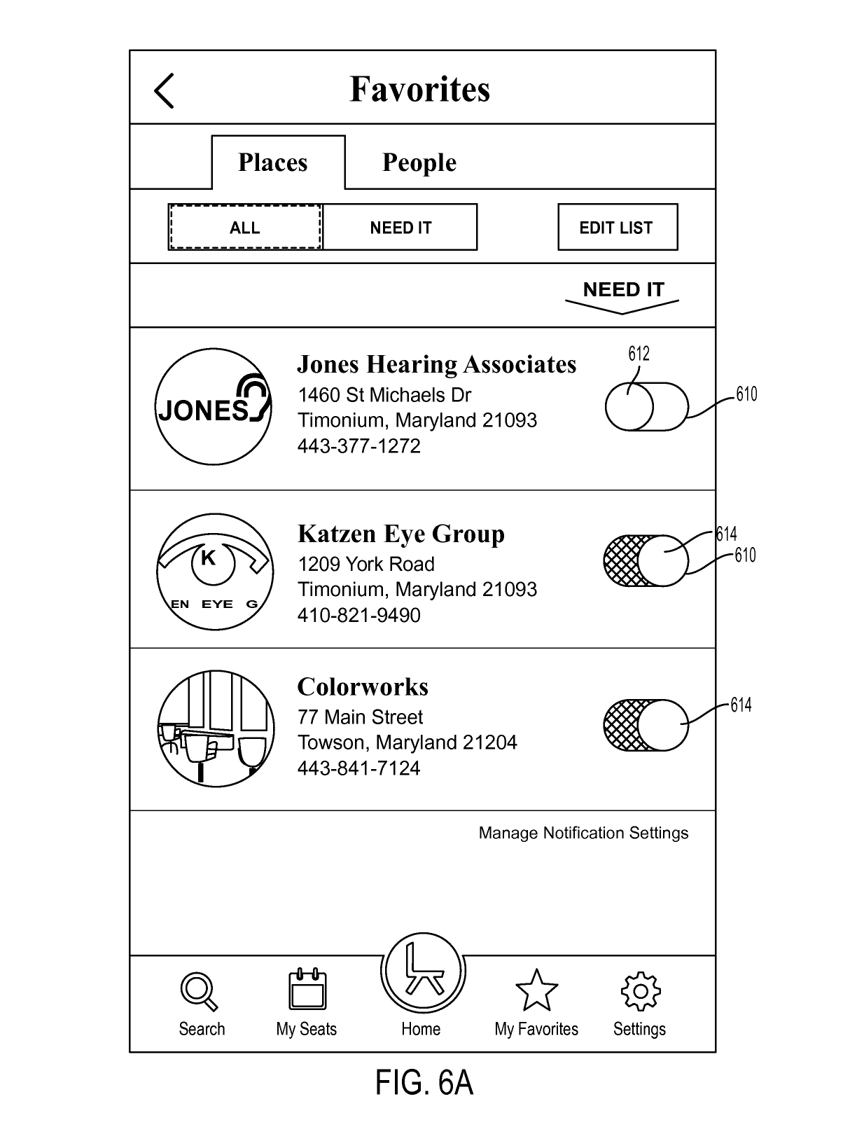

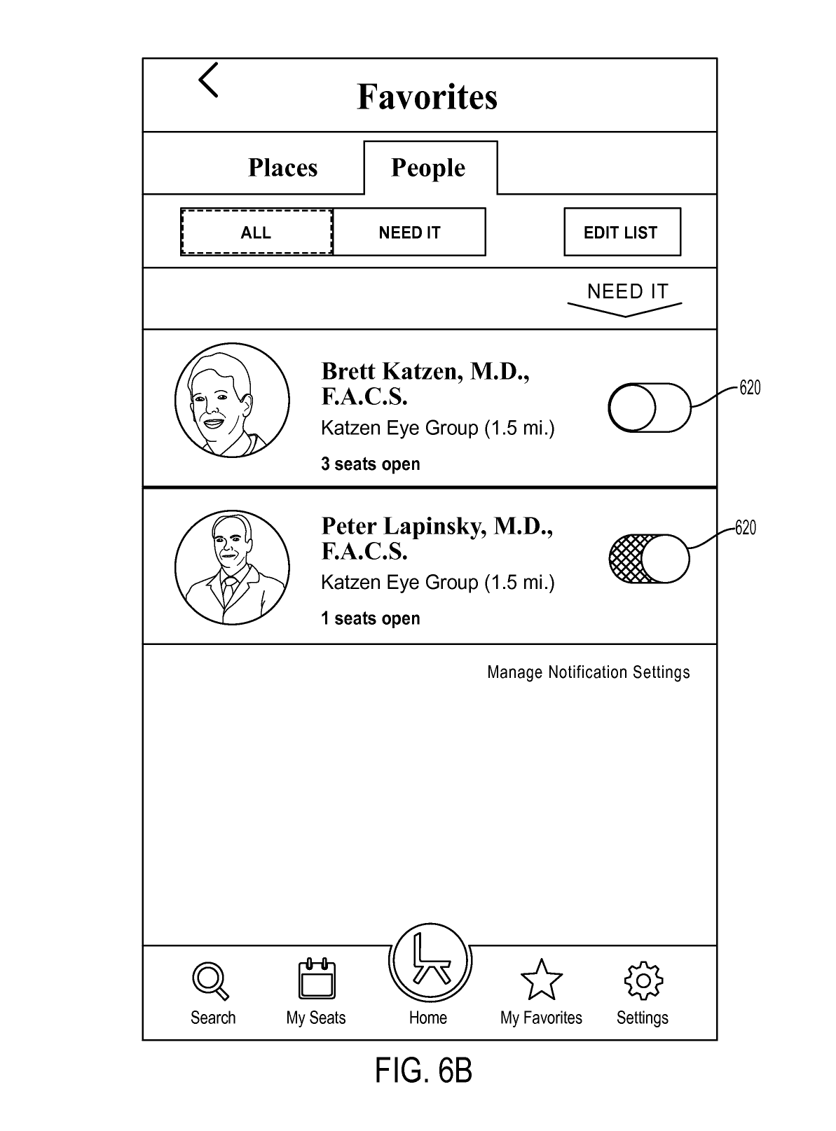

Although software module 165 may be described in relation to server 150, software module 165 may reside on any other device. Further, the functionality of software module 165 may be duplicated on, distributed across, and/or performed by one or more other devices, either in whole or in part. Subscribers (or consumers) can connect to the computer system 100 through individual user devices 120-1, 120-2, 120-3. As seen in FIG. 2A, through an individual user device 120-1, a user can download an application or software module S200 and register S205 by providing name, email and address information. Additionally, a user can set favorites S210 that are customizable to the user. Subscribers can “favorite” the service providers they typically see, which flags these service providers in the subscriber's account. Subscribers can tend to have five to eight favorite service providers that they see (e.g., dental, eye doctor, dermatologist, haircut, pediatrician, yoga, personal trainer, veterinarian, etc.). Additional detail regarding favorites can be seen in FIGS. 6A and 6B, as described hereinafter.

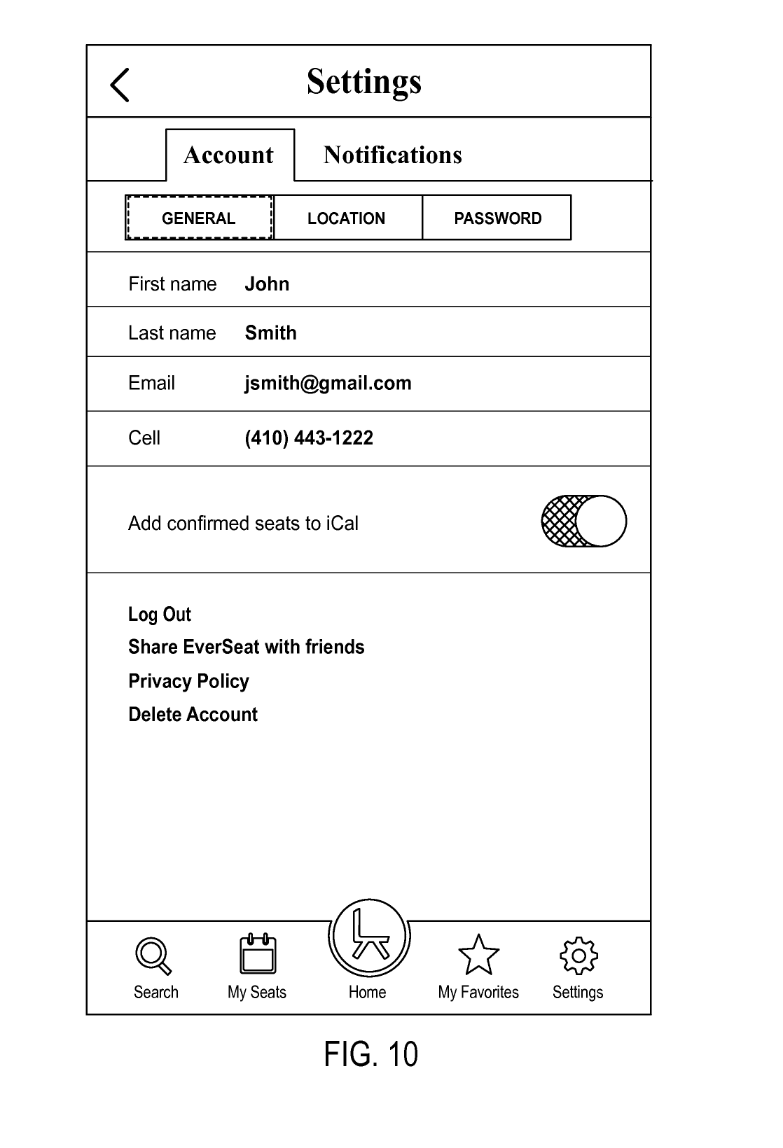

If a subscriber is in search of a haircut, he or she would want to be notified of open appointments. If the user is not in search of a haircut, he or she would not want to be notified of open appointments. A subscriber can set notification settings S215, as can also be seen in FIG. 10. For example, a subscriber can input to a settings section (e.g., press settings button S220). Additionally, a subscriber can input to a notifications section (e.g., press a notifications button S225) to provide an interface for customizing notifications. For example, customized notifications can include preferred means of being notified, for example, via SMS/text messages, email messages, telephone calls, push notifications S230, other mechanisms of notification, or some combination or all of the above. Additionally, the subscriber can select an expiration of the notification S235, a time or date after which the user would no longer wish to receive notifications either for a particular appointment, a particular third party, a particular professional, or a particular service. Thus, subscribers can control the notification method and process for appointments, for example. The third party can be a service provider or a provider of goods from which users or customers buy services or goods. Thus, in some embodiments, the subscriber is enabled to control how and when he or she is notified about open appointments.

Embodiments of the invention can include systems and devices that can be performed on a computer system and/or a non-transitory computer readable storage medium. Further, embodiments of the invention can be a computer-implemented method. While disclosure with reference to embodiments on a computer system is made, it is to be understood that similar embodiments either on a non-transitory computer readable storage medium or computer-implemented method are also contemplated within the scope of the invention.

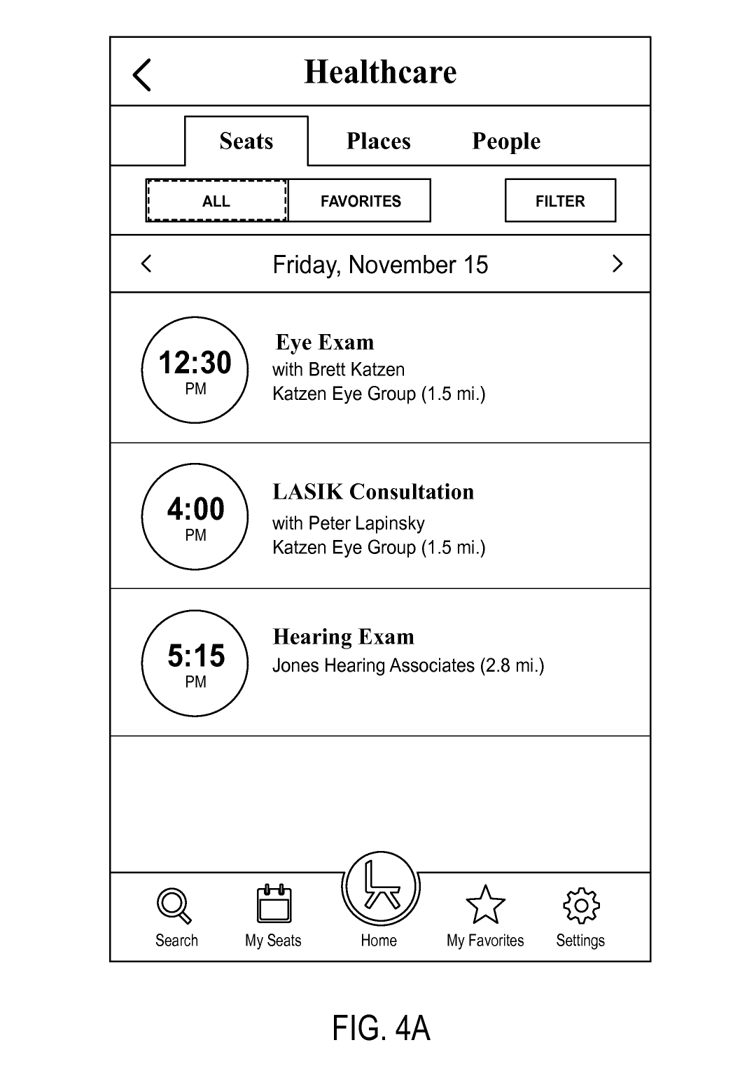

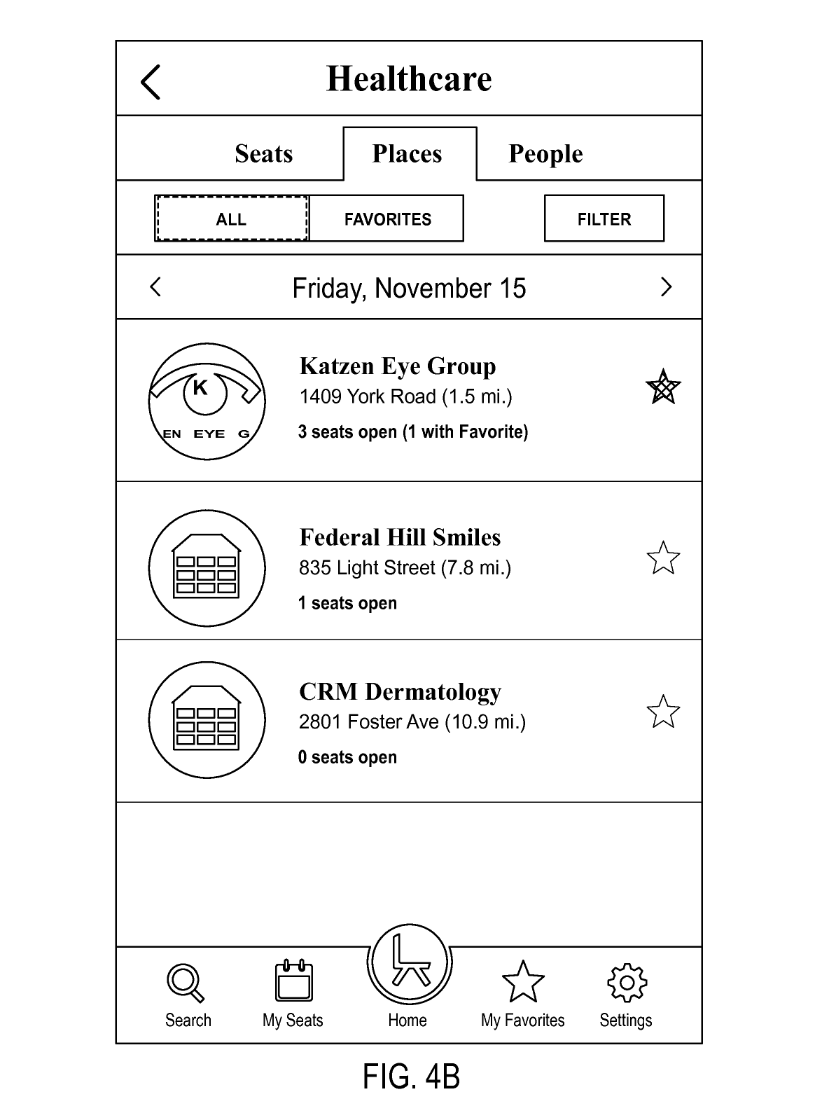

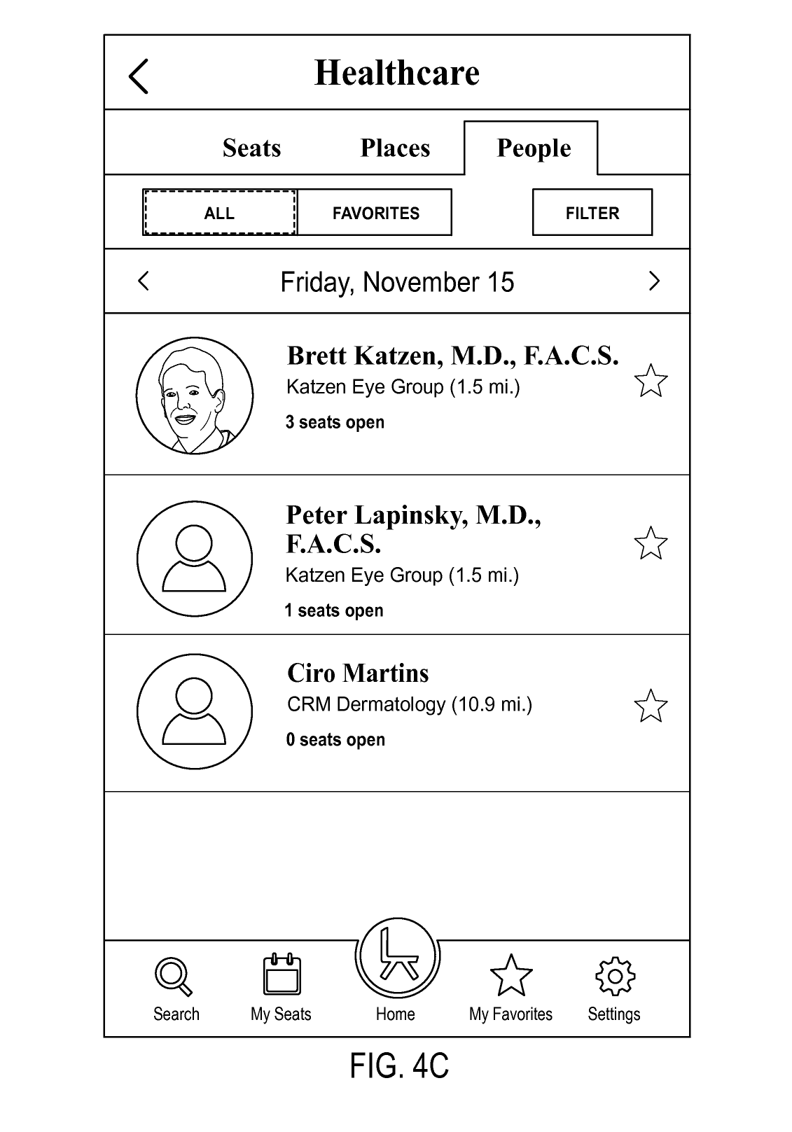

The computer system 100 can connect to a database on a server that maintains schedule data of third parties. FIGS. 4A-4C show a standard setting where a subscriber can see any and all open appointments. In the standard setting, notifications need not be sent, and a subscriber can simply browse and grab any desired appointment. As seen from FIG. 4A, the schedule data can have at least one third party entry, or appointment, that includes a service type and service time. Each of the at least one third party entry can have an availability profile. An availability profile can indicate that the third party entry is assigned to one or more person and/or has an opening or availability. FIG. 4A shows available third party entries in the service category of health care, with each entry showing a type of health care service from a perspective of a seat, or specific type of appointment. Each third party entry also shows a service time, for example, of the specific type of appointment.

FIG. 4B shows an alternate view of FIG. 4A showing the third parties in the specific category (e.g., of health care) and associated location, as well as the number of third party entries or appointments. As can be seen from the FIG. 4B, the computer system 100 can display third parties that do not have any seats or specific appointments available.

FIG. 4C shows an alternate view of FIGS. 4A and 4B showing names of practitioners of the third parties.

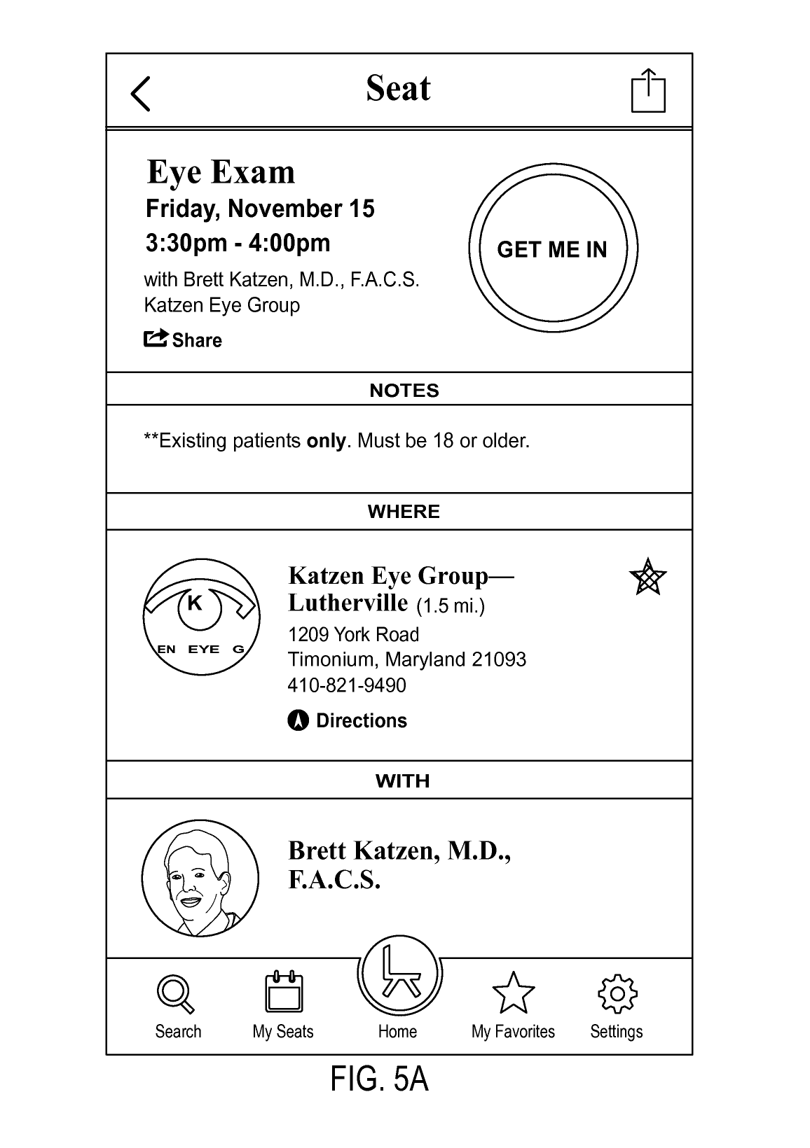

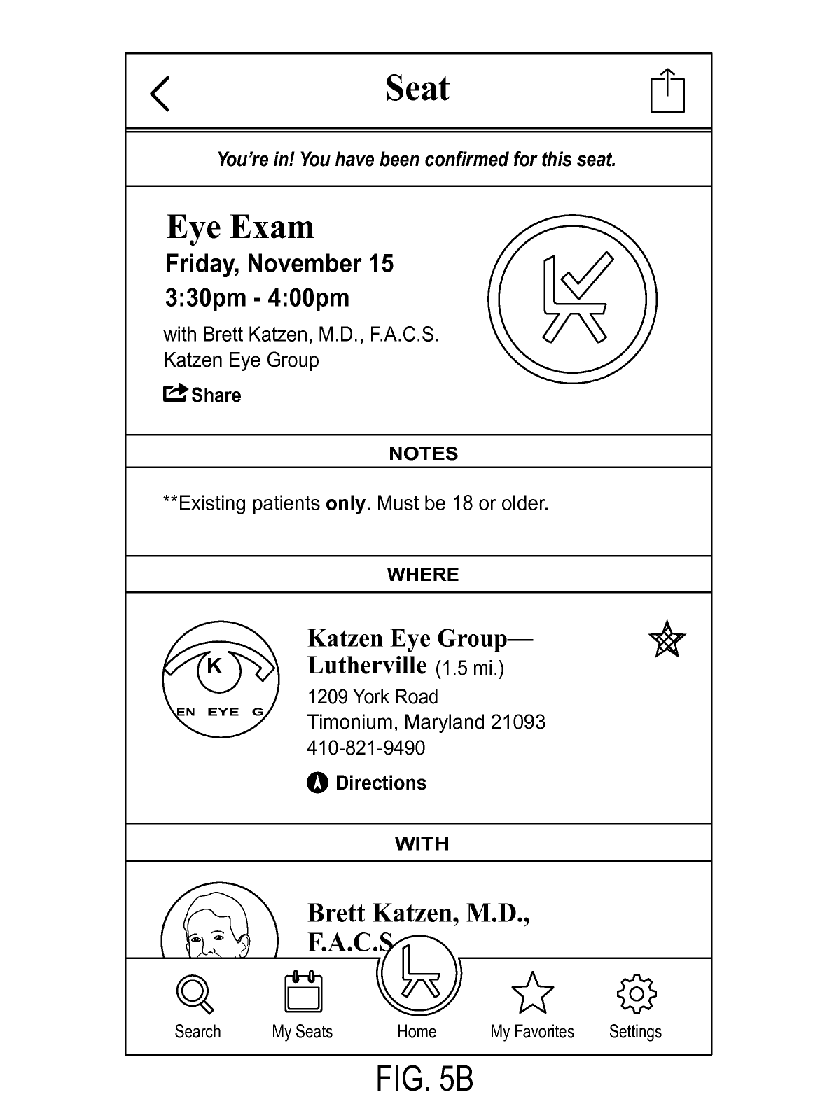

FIG. 5A shows a display of a third party entry that has an open availability profile. In one embodiment, an input option labeled “Get Me In” is shown that allows for a user to select the third party entry. Additionally, FIG. 5A shows that a location of the third party and the name of the practitioner associated with the third party entry can be displayed.

FIG. 5B shows that a confirmation can be displayed after a user has selected and the third party entry has successfully been assigned to the user account.

FIG. 6A shows another embodiment that uses notifications to alert subscribers of appointments. In this embodiment, a pool of supply services (e.g., hair cut & color, eye exam, acupuncture, dental appointment, Botox treatment, spin class, etc.) can find the demand (subscribers or users) using cloud computing. FIG. 6A shows a display of a user's favorites, according to the service provider. Identifying and displaying favorites make search easier and allows for easier access to change notifications about relevant appointments. For example, some people may not prefer to search for dental appointments with a dentist that they do not already see. In FIG. 6A, third party service providers can be selected as needed even when the third parties associated with third party entries do not have open availability profiles. In FIG. 6A, each of the places associated with desired third party entries can be displayed along with a service provider desirability input field 610 (or “Need It” section), which can either be selected 612 or unselected 614. For example, a Colorworks third party may not have any available third party entries, and selecting the detailed third party view, such as shown in FIG. 5A, may not allow the user to select an appointment. However, in the desired view, a user can select the desirability profile of the third party. When “Need it” is selected, a subscriber can be actively notified, such as through push notifications, text and/or email messaging. The variety of notifications ensures a greater likelihood of reaching the subscriber when he or she needs an appointment.

FIG. 6B shows an alternate view of FIG. 6A shown at the level of practitioners within the third party. Similar to FIG. 6A, a user can select a practitioner desirability input field 620 even if the practitioner is unavailable to schedule an appointment with. The activation of this desirability input field can be associated with a user account. The computer system 100 can keep track of each change to the desirability input fields of the users in the aggregate. Thus, desired appointments of at least one subscriber account can be monitored against the availability profiles of the at least one third party entry of the schedule data in the database. Each of the desired appointments can include a type and time of service, and at least one desired appointment can correspond to the at least one third party entry.

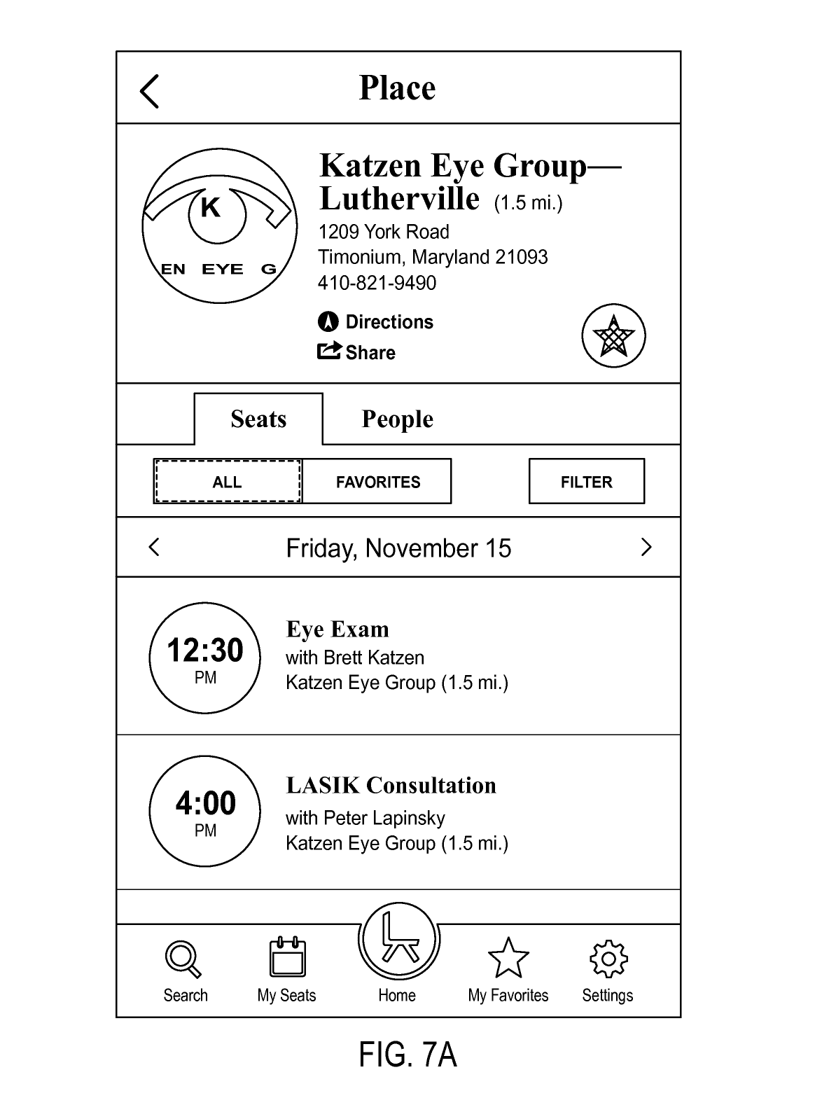

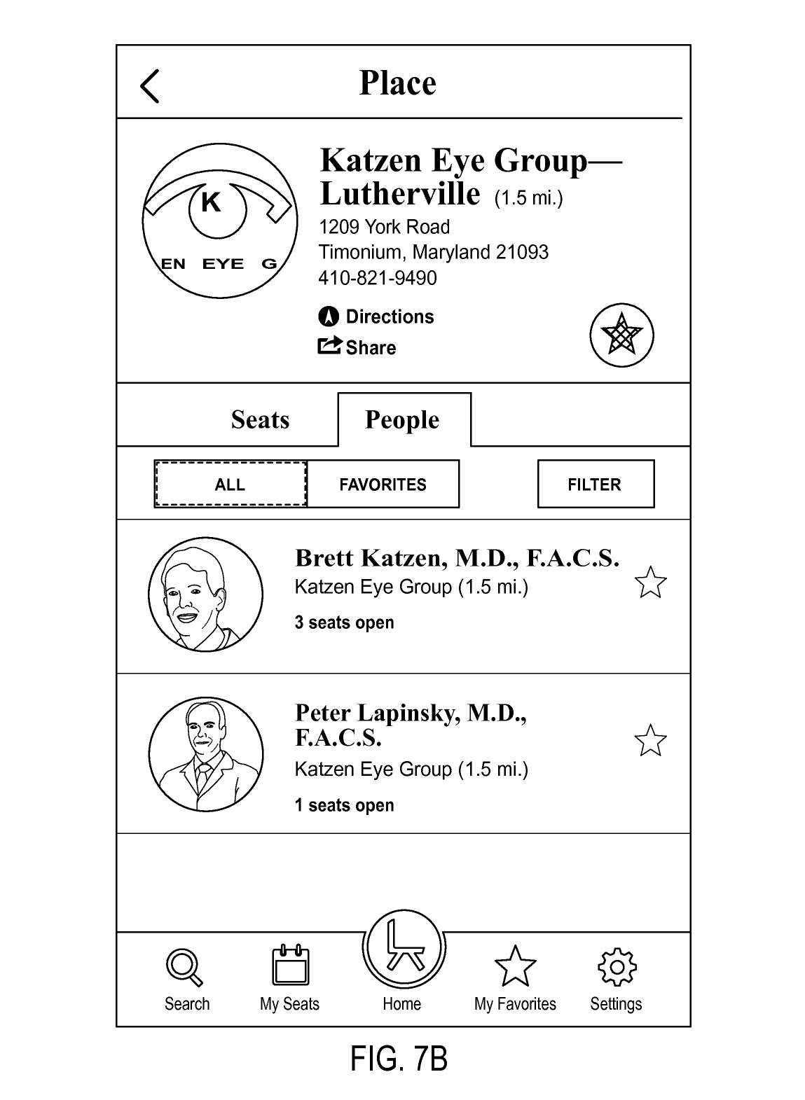

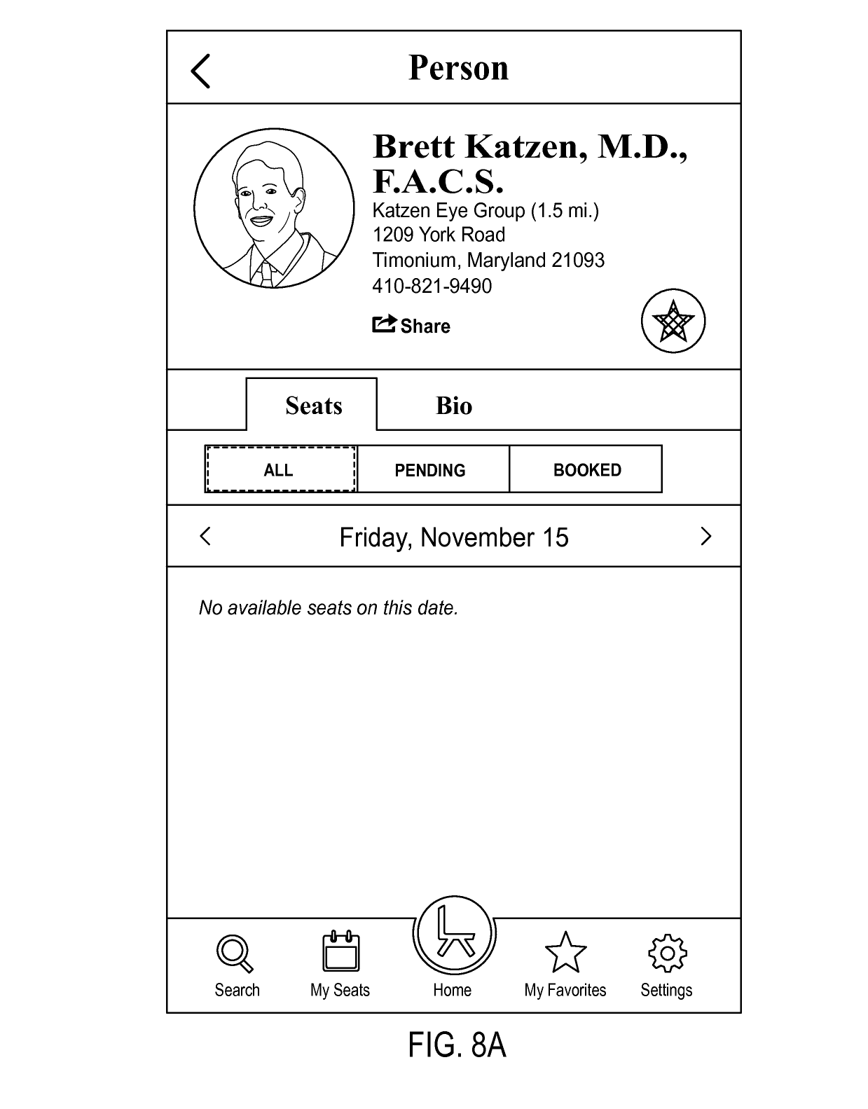

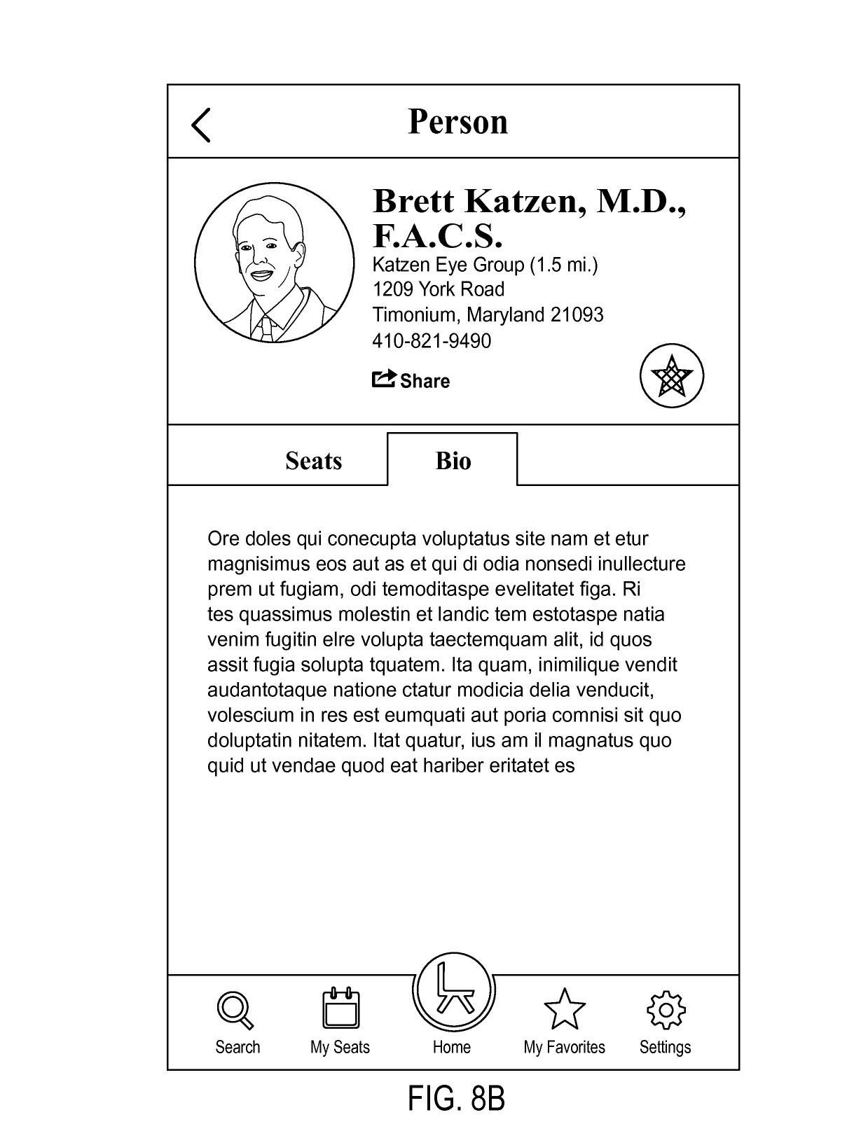

FIG. 7A shows a view from a perspective of appointments related to a third party (e.g., service provider). For example, a single service provider can include various services at various time slots. From this section, a user can select an appointment that corresponds to this service provider. FIG. 7B shows an alternate view of FIG. 7A from a perspective of practitioners of the service provider, along with availabilities of the practitioner. Each of the practitioner profiles are selectable, as can be seen in FIGS. 8A and 8B.

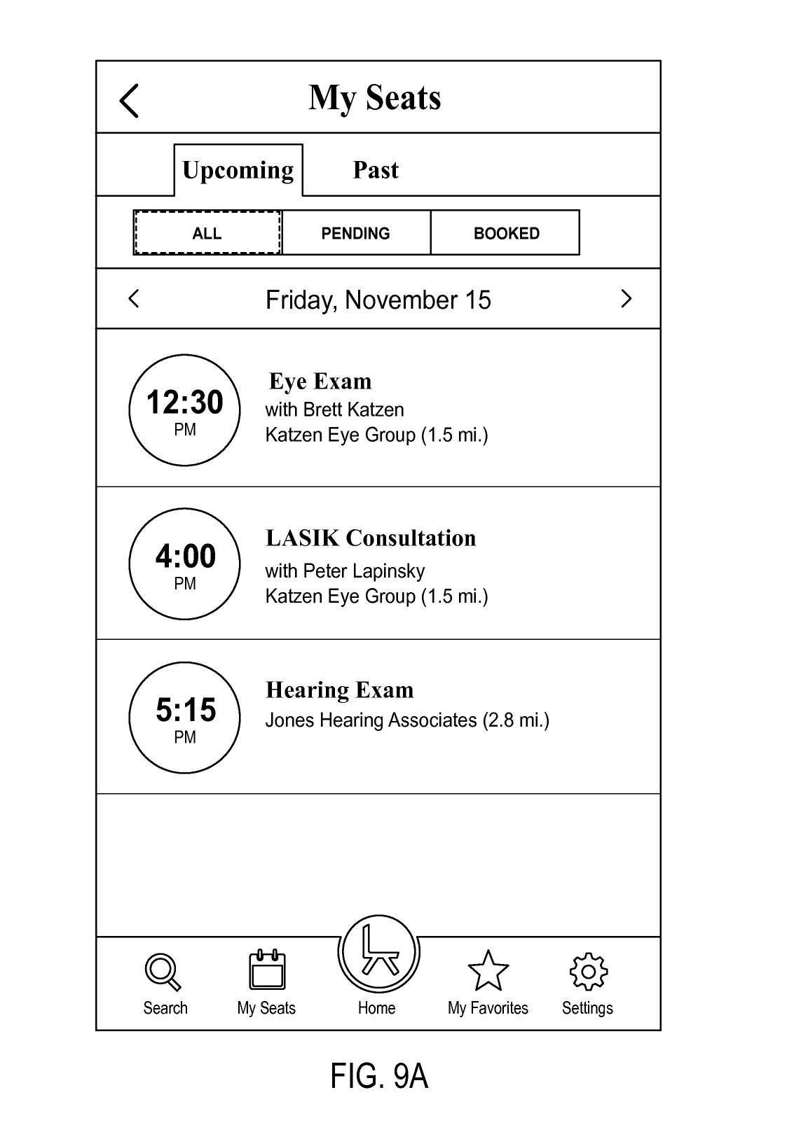

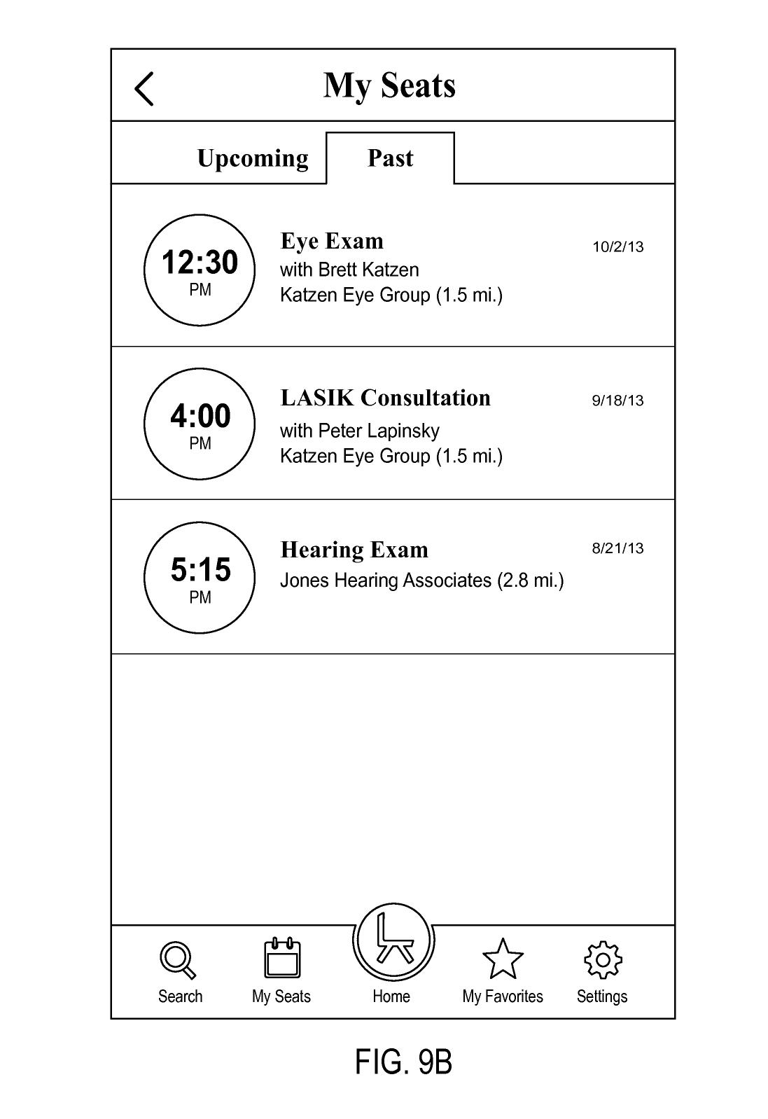

FIG. 8A shows an expanded view of the available appointments of the practitioner for a particular configurable date. FIG. 8B shows an alternate view of FIG. 8A that details specific information regarding the practitioner. FIG. 9A shows a display of a user's upcoming appointments, and FIG. 9A shows a display of a user's past appointments.

The computer system 100 can receive a cancellation of an appointment. The canceled appointment can correspond to a third party entry of the third parties. In one embodiment, as can be seen in FIG. 2A, a service provider can post an appointment (e.g., a new availability or a canceled appointment) via the Internet. Thus, the computer system 100 can receive either by manual input from a third party or by the database interfacing with an automated scheduling software of the third party. The computer system 100 can include software that automatically interfaces with software of the third party service providers. The interface can include a third party application program interface (API), such as by Athena (R) or Dentrix (R). Thus, the connecting to the database can include automatically interfacing with scheduling software of the third party.

The computer system 100 can update the availability profile of the third party entry in the database that corresponds to the canceled appointment. In one embodiment, when a third party entry is canceled, a third party can transmit a notification to the database that a cancellation has taken place. Further, when the subscribers have accepted the input, the server can send a notification to the third party for updating purposes.

The computer system 100 can create a cancellation notification based on existing desired appointments for the third party entry. The cancellation notification can be associated with a service type and service time of the schedule data.

The computer system 100 can send a cancellation notification to at least one of the at least one subscriber. The sending can take place based on a subscriber activating the type and time of service that corresponds to the service type and service time of the cancellation notification. Thus, as shown in FIG. 2A, the user can be notified by the computer system (e.g., push and text) S245. After the notification has been sent to the user, the user can see the notification S250 on his or her user device.

The computer system 100 can accept input related to the cancellation notification from subscribers to whom a cancellation notification was sent. In one embodiment, the user can click a button, such as “Get Me In” S255, as also seen on FIG. 5A.

The computer system 100 can update the database to add the canceled appointment and associated subscriber information from a subscriber based on the input from the subscribers. In one embodiment, the input of the subscriber on which the updating is based can be the time that a subscriber selects an input field. The input field can be in the form of a button, a hyperlink, or any other suitable input option that is selected by a subscriber. The input from the subscribers including a timestamp of the input can be stored by a single writable database to ensure that order of the received inputs is consistently tracked. In one embodiment, the database can be updated based on the first subscriber being assigned to the canceled appointment.

The updating the database step can also be based on information of the subscribers. For example, rating information about each subscriber can be collected or accepted from one or more service providers. The rating information of a subscriber by a third party can be based on the subscriber's timeliness to, cancelation of, or failure to show up to, the one or more of appointments of the third party. The rating information can be assessed based on the subscriber's timeliness to appointments. Rating information can also be assessed based on whether the subscriber misses an appointment altogether, or based on the frequency of appointment reschedules. For example, a service provider could use a predetermined threshold for a subscriber rating information in scheduling a subscriber. In one embodiment, a subscriber who is outside of a geographically feasible range or who does not meet the rating information of the service provider does not have the service provider displayed to his/her account. This can save computing efficiencies to the user device by filtering the results of the possible appointments.

In another embodiment, rating information of the subscriber can influence whether the database is updated to assign the subscriber to the appointment in a certain time interval. For example, if a subscriber attempts to schedule an appointment to a service provider for which the subscriber's rating information does not meet a predetermined threshold, a delay can take place that can allow for another subscriber to accept the appointment meeting the rating information predetermined threshold. In one embodiment, the delay can be a second or two. In another embodiment, the delay can extend up to minutes or hours or even up until the time of the appointment. This can allow the service provider additional time to get a qualified customer. Thus, rating information, for example, can be used in the determination of which subscriber is updated to be assigned to a particular appointment.

In addition to rating information, real-time location information of a subscriber can be determined, for example, based on a GPS receiver of the subscriber's user device. Thus, real-time location information of the subscriber can be tracked in relation to a GPS receiver of the subscriber to a location of the third party. Location information, for example, can be used in the determination of which subscriber is updated to be assigned to a particular appointment. For example, if location information of a subscriber is received that is improbable that the subscriber could make the appointment based on the distance between the subscriber and the location of the service provider of the appointment, the computer system 100 can keep the appointment open for another interested subscriber. Thus, when at least two subscribers have accepted the input of a third party entry that corresponds to a cancellation, the third party entry in the database is updated to (or awarded to) a subscriber that first accepts the input.

In another embodiment, when a subscriber pushes the button to grab an appointment, the open availability goes away thus preventing other subscribers from selecting the grab functionality of the same appointment. After the subscriber has pushed the button, service provider staff are alerted to the appointment request on the screen of the service provider that is coupled to the computing system. The service provider can be prompted to approve by clicking a confirmation button. The database is then updated upon confirmation.

The computer system 100 can include notifying the third party that corresponds to the canceled appointment about the updated canceled appointment. The computer system 100 can also include notifying the at least one subscriber that accepted the input related to the cancellation notification about the updated canceled appointment. Thus, the computer system 100 can confirm the appointment S260, as shown in FIG. 2A. Thus the computer system 100 can award the desired type and time of service of the cancellation to at least one of the subscribers based on the accepted input. Upon confirmation, an appointment can appear in a calendar in the account of the subscriber.

The computer system 100 can also perform at least one specifically tailored task to the subscriber based on the rating information of the subscriber by the third party or by other third parties. For example, the at least one specifically tailored task can be at least one of sending a reminder by way of, for example, email or text prior to the appointment, calling the subscriber prior to the appointment, or double-booking for the appointment. The rating information of the subscriber can be anonymized and encrypted for use by third parties.

In an embodiment, as shown in FIG. 2B, a service provider can have a full schedule at the beginning of the day S265, shortly after which a patient can call to cancel an appointment S270. The cancellation can be posted S275 either through an automatic scheduling software of the service provider, or through a staff member uploading the availability to the server. Next, a user in the region can see the posted cancellation on a user device S280. Next, the user can successfully grab the appointment using the service S285.

The computer system 100 can include removing the listing from the database, after a predetermined time following a cancellation, to allow for the corresponding third party to open the service time for a walk-in appointment. For example, in the case of after an available or newly posted canceled appointment has been available, a third party may retrieve the availability of the appointment prior to the appointment start time to facilitate a walk-in customer taking the appointment. This predetermined time can include a predetermined time before a start time of the service time.

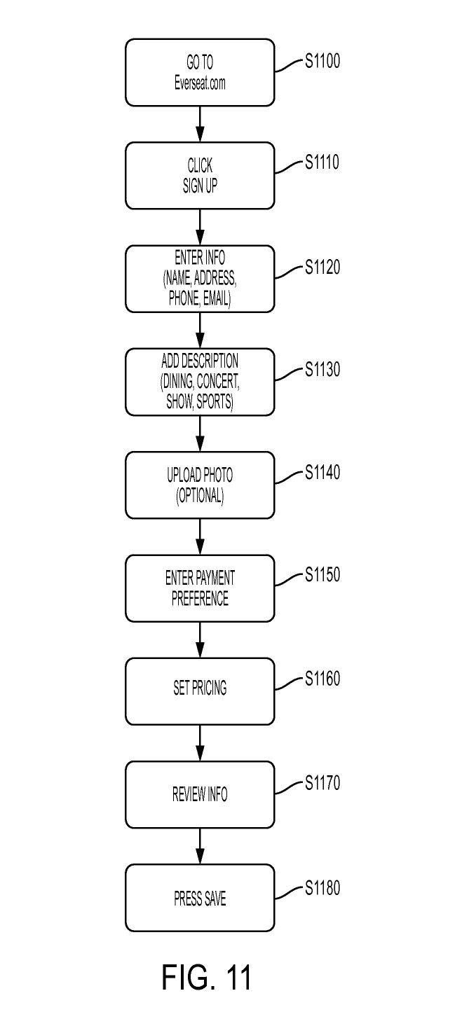

FIG. 11 shows a flowchart of a service provider posting an appointment to the system. In step S1100, a service provider user can go to a website after which the service provider can sign up S1110. In S1120, the service provider can enter personal information of the service provider after which it can be prompted to add description S1130. In step S1140, a photo can be optionally uploaded. In S1150, a payment preference may be entered, after which the price can be set S1160. After reviewing the information S1170 and pressing save S1180, a service provider profile can be created.

For the computer system, an account of the at least one subscriber can be linked to at least one family member such that the subscriber to whom a notification is sent is for the at least one family member. The data structure of the subscriber account allows for a broad definition of a family member. For example, a family member can be any one of a child, a spouse, a parent, a sibling, a partner, a pet, a ward, a godchild, an extended family relationship, or any other relationship that relates to family, etc.

In an exemplary embodiment of the invention, a mobile application is provided that allows a subscriber to view available appointments at a service provider. The subscriber can select the desired appointment and transmit the selection with one user action. There is no need for the subscriber to log-in, call or otherwise take action to contact the service provider. For example, the subscriber may be provided with an icon via the mobile application. Touching the icon via a touch screen or other selection method causes automatic selection and transmission of the selected appointment to the service provider. A real-time or near real-time notification is provided to the service provider. For example, after the subscriber selects an appointment, the acceptance is shown at a computing device at the service provider. The service provider may then accept and/or confirm the appointment.

In another exemplary embodiment, the subscriber may register for desired services. For example, a subscriber may desire an appointment with a particular service provider, but the service provider does not currently have an available appointment at the desired date or time range. The subscriber may select the service provider via the mobile application and indicate that they need an appointment. The application and server may track the subscriber's requests. If the service provider has a cancelation, the service provider may update their schedule in the system. The system can match subscriber demand and service provider supply in the cloud. When there is a match, the system can automatically notify the subscriber of the appointments' availability. The notification may be via a text message, via the mobile application or, preferably, both. No user action is required to receive the notification. The subscriber may select the appointment via the mobile application.

In another embodiment of the invention, a subscriber may purchase accelerated access to a service provider. For example, a subscriber can pay extra for accelerated access to an appointment. In this embodiment, subscribers can use personal payment accounts, such as credit cards, directly on the website or directly within the mobile application. Subscribers can search for access to coveted appointments or spots and pay the posted price for access. Ideal for dining, recreational, leisure and luxury experiences, the extra fee can be a range based on demand of the service. In some embodiments, the accelerated access can be confidential such that other patrons do not know that the accelerated subscriber used accelerated access for the service.

A service provider may directly post an available appointment and the set price to the system. There may be no secondary market involved. For example, a restaurant may post that a table for 4 is available at 7 pm on a Saturday night for a set price. A subscriber may use the mobile application to purchase the table. If the offer is not accepted, for example by a predetermined time, the offer may be removed from the system and the restaurant may provide the table to a walk-in.

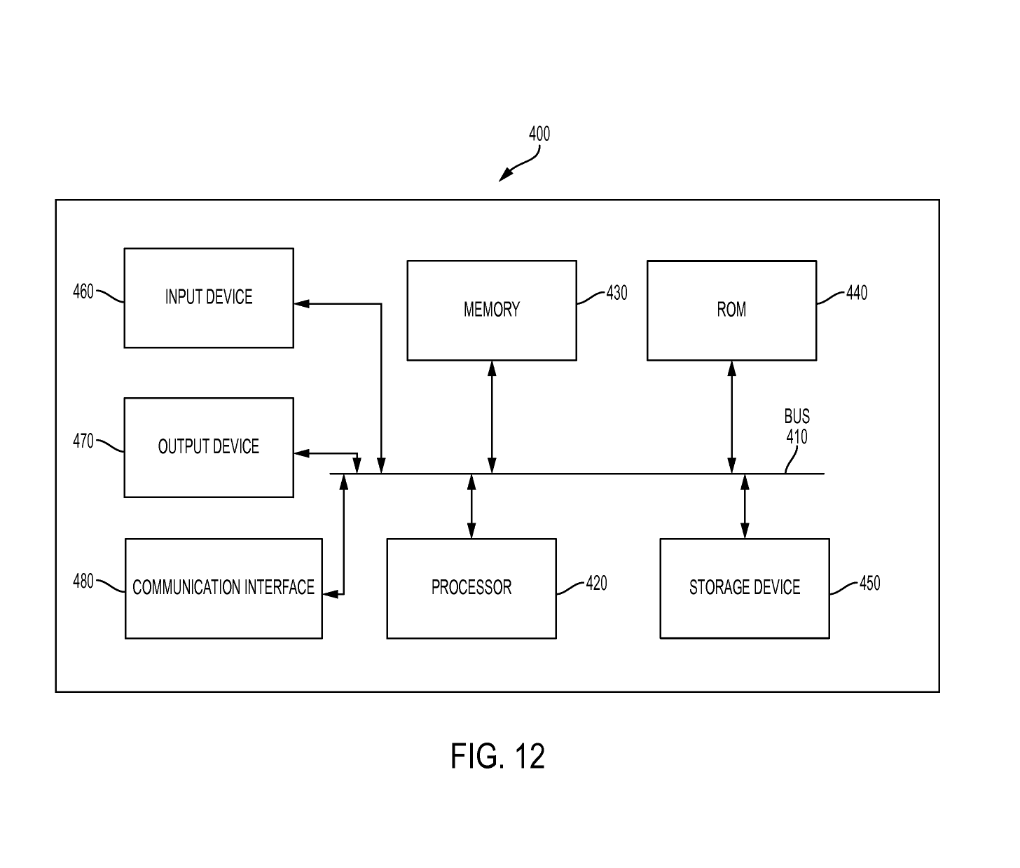

FIG. 12 depicts an exemplary architecture for implementing a computing device 400 in accordance with one or more embodiments, which may be used to implement any of the computing devices discussed herein, or any other computer system 100 or computing device component thereof. It will be appreciated that other devices that can be used with the computing device 400, such as a client or a server, may be similarly configured. As illustrated in FIG. 4, computing device 400 may include a bus 410, a processor 420, a memory 430, a read only memory (ROM) 440, a storage device 450, an input device 460, an output device 470, and a communication interface 480.

Bus 410 may include one or more interconnects that permit communication among the components of computing device 400. Processor 420 may include any type of processor, microprocessor, or processing logic that may interpret and execute instructions (e.g., a field programmable gate array (FPGA)). Processor 420 may include a single device (e.g., a single core) and/or a group of devices (e.g., multi-core). Memory 430 may include a random access memory (RAM) or another type of dynamic storage device that may store information and instructions for execution by processor 420. Memory 430 may also be used to store temporary variables or other intermediate information during execution of instructions by processor 420.

ROM 440 may include a ROM device and/or another type of static storage device that may store static information and instructions for processor 420. Storage device 450 may include a magnetic disk and/or optical disk and its corresponding drive for storing information and/or instructions. Storage device 450 may include a single storage device or multiple storage devices, such as multiple storage devices operating in parallel. Moreover, storage device 450 may reside locally on the computing device 400 and/or may be remote with respect to a server and connected thereto via network and/or another type of connection, such as a dedicated link or channel.

Input device 460 may include any mechanism or combination of mechanisms that permit an operator to input information to computing device 400, such as a keyboard, a mouse, a touch sensitive display device, a microphone, a pen-based pointing device, and/or a biometric input device, such as a voice recognition device and/or a finger print scanning device. Output device 470 may include any mechanism or combination of mechanisms that outputs information to the operator, including a display, a printer, a speaker, etc.

Communication interface 480 may include any transceiver-like mechanism that enables computing device 400 to communicate with other devices and/or systems, such as a client, a server, a license manager, a vendor, etc. For example, communication interface 480 may include one or more interfaces, such as a first interface coupled to a network and/or a second interface coupled to a license manager. Alternatively, communication interface 480 may include other mechanisms (e.g., a wireless interface) for communicating via a network, such as a wireless network. In one implementation, communication interface 480 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 400 may perform certain functions in response to processor 420 executing software instructions contained in a computer-readable medium, such as memory 430. In alternative embodiments, hardwired circuitry may be used in place of or in combination with software instructions to implement features consistent with principles of the disclosure. Thus, implementations consistent with principles of the disclosure are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof

While various exemplary embodiments have been described above, it should be understood that they have been presented by way of example only, and not limitation. Thus, the breadth and scope of the present disclosure should not be limited by any of the above-described exemplary embodiments.

We claim:

1. A computer system for managing third party availability profiles, comprising:
a memory that is configured to store computer-executable instructions; and
at least one processor that is coupled to the memory and that is configured to execute the computer-executable instructions to perform:
connecting to a database on a server that maintains schedule data of third parties, the schedule data having at least one third party entry that includes a service type and service time, each of the at least one third party entry having an availability profile;
monitoring desired appointments of at least one subscriber account against the availability profiles of the at least one third party entry of the schedule data in the database, each of the desired appointments including a type and time of service, at least one desired appointment corresponding to the at least one third party entry;
receiving a cancellation of an appointment, the appointment corresponding to one or more of the third party entries of the third parties;
updating the availability profile of the third party entry in the database that corresponds to the canceled appointment;
creating a cancellation notification based on existing desired appointments for the third party entry, the cancellation notification being associated with a service type and service time of the schedule data;
sending a cancellation notification to at least one of the at least one subscriber, the sending taking place based on the at least one subscriber activating the type and time of service that corresponds to the service type and service time of the cancellation notification;
accepting input related to the cancellation notification from subscribers to whom a cancellation notification was sent;
updating the database to add the canceled appointment and associated subscriber information from a subscriber based on the input from the subscribers; and
notifying at least one of: i) the third party that corresponds to the canceled appointment and ii) the at least one subscriber that accepted the input related to the cancellation notification, about the updated canceled appointment.

2. The computer system of claim 1, wherein the database is updated when the third party entry is canceled.

3. The computer system of claim 1, wherein:
when a third party entry is canceled, a third party transmits a notification to the database that a cancellation has taken place, and
when the subscribers have accepted the input, the server sends a notification to the third party for updating purposes.

4. The computer system of claim 3, wherein the connecting to the database includes automatically interfacing with scheduling software of the third party.

5. The computer system of claim 1, wherein when at least two subscribers have accepted the input of a third party entry that corresponds to a cancellation, the third party entry in the database is updated to a subscriber that first accepts the input.

6. The computer system of claim 1, wherein the memory further comprises instructions that, when executed, perform:
removing the third party entry from the database, after a predetermined time following a cancellation, to allow for the corresponding third party to open the service time for a walk-in appointment.

7. The computer system of claim 6, wherein the predetermined time includes a predetermined time before a start time of the service time.

8. The computer system of claim 1, wherein the notification is one of a text, an email, and a push notification.

9. The computer system of claim 1, wherein the memory further comprises instructions that, when executed, perform:
accepting rating information of a subscriber by a third party based on a subscriber's timeliness to, cancelation of, or failure to show up to the one or more of appointments of the third party.

10. The computer system of claim 9, wherein the memory further comprises instructions that, when executed, perform:
performing at least one specifically tailored task to the subscriber based on the rating information of the subscriber by the third party or by other third parties.

11. The computer system of claim 10, wherein:
real-time location information of the subscriber is tracked in relation to a GPS receiver of the subscriber to a location of the third party, and the performing is also based on the location information of the subscriber.

12. The computer system of claim 10, wherein the at least one specifically tailored task is at least one of sending a reminder prior to the appointment, calling the subscriber prior to the appointment, or double-booking for the appointment.

13. The computer system of claim 10, wherein the rating information of the subscriber is anonymized and encrypted for use by third parties.

14. The computer system of claim 1, wherein an account of the at least one subscriber is linked to at least one family member such that the subscriber to whom the notification is sent is for the at least one family member.

15. A computer-implemented method for managing third party availability profiles, comprising:
connecting to a database on a server that maintains schedule data of third parties, the schedule data having at least one third party entry that includes a service type and service time, each of the at least one third party entry having an availability profile;
monitoring desired appointments of at least one subscriber account against the availability profiles of the at least one third party entry of the schedule data in the database, each of the desired appointments including a type and time of service, at least one desired appointment corresponding to the at least one third party entry;
receiving a cancellation of an appointment, the appointment corresponding to one or more of the third party entries of the third parties;
updating the availability profile of the third party entry in the database that corresponds to the canceled appointment;
creating a cancellation notification based on existing desired appointments for the third party entry, the cancellation notification being associated with a service type and service time of the schedule data;
sending a cancellation notification to at least one of the at least one subscriber, the sending taking place based on the at least one subscriber activating the type and time of service that corresponds to the service type and service time of the cancellation notification;
accepting input related to the cancellation notification from subscribers to whom a cancellation notification was sent;
updating the database to add the canceled appointment and associated subscriber information from a subscriber based on the input from the subscribers; and
notifying at least one of: i) the third party that corresponds to the canceled appointment and ii) the at least one subscriber that accepted the input related to the cancellation notification, about the updated canceled appointment.

16. A non-transitory computer readable storage medium having instructions that, when executed by at least one processor, cause a computing system to perform steps of:
connecting to a database on a server that maintains schedule data of third parties, the schedule data having at least one third party entry that includes a service type and service time, each of the at least one third party entry having an availability profile;
monitoring desired appointments of at least one subscriber account against the availability profiles of the at least one third party entry of the schedule data in the database, each of the desired appointments including a type and time of service, at least one desired appointment corresponding to the at least one third party entry;
receiving a cancellation of an appointment, the appointment corresponding to one or more of the third party entries of the third parties;
updating the availability profile of the third party entry in the database that corresponds to the canceled appointment;
creating a cancellation notification based on existing desired appointments for the third party entry, the cancellation notification being associated with a service type and service time of the schedule data;
sending a cancellation notification to at least one of the at least one subscriber, the sending taking place based on the at least one subscriber activating the type and time of service that corresponds to the service type and service time of the cancellation notification;
accepting input related to the cancellation notification from subscribers to whom a cancellation notification was sent;
updating the database to add the canceled appointment and associated subscriber information from a subscriber based on the input from the subscribers; and
notifying at least one of: i) the third party that corresponds to the canceled appointment and ii) the at least one subscriber that accepted the input related to the cancellation notification, about the updated canceled appointment.
